(19) United States
(12) Patent Application Publication
(10) Pub. No.: US 2009/0241410 A1
(43) Pub. Date: Oct. 1, 2009

(54) APPARATUS FOR PROTECTING AGAINST INSECT ATTACKS

(76) Inventor: Raleigh William Baird, III, Houston, TX (US)

Correspondence Address: CONLEY ROSE, P.C.;David A. Rose, P. O. BOX 3267, HOUSTON, TX, 77253-3267, US

(21) Appl. No.: 12/470,179

(22) Filed: May 21, 2009

Related U.S. Application Data
(63) Continuation-in-part of application No. 11/346,035, filed on Feb. 2, 2006.
Application No. 11/346,035 is a continuation-in-part of application No. 11/545,864, filed on Oct. 11, 2006.

(51) Int. Cl. A01M 7/00; B05B 1/00; B05B 9/043; B05B 15/06

(52) U.S. Cl. 43/132.1; 239/172; 239/525; 239/536; 239/602; 239/1

(57) ABSTRACT

Herein disclosed are apparatus and methods for protecting against and stopping an attack by flying stinging insects. Such an apparatus comprises a tank configured to contain a surfactant solution; a pump in fluid communication with the tank; a delivery system having at least one nozzle; a first tubular member fluidly connecting the tank and the delivery system; and an actuator coupled to the pump and operable by the operator of the vehicle, for activating the pump; wherein the tank, the pump, the delivery system, and the first tubular member are attached to a ridable vehicle and configured to deliver the surfactant solution onto the operator and the attacking insects at a flow rate in the range of 1-3 gallons/min, to dispel the insect attack, upon operation of the actuator when the assembly is used to stop an attack of aggressive flying stinging insects.

### CROSS-REFERENCE TO RELATED APPLICATIONS

The present application is a continuation-in-part of U.S. patent application Ser. No. 11/346,035, filed on Feb. 2, 2006 and a continuation-in-part of U.S. patent application Ser. No. 11/545,864, filed on Oct. 11, 2006, the disclosures of which are hereby incorporated herein by reference.

### FIELD OF THE INVENTION

The present invention relates generally to protecting an individual against flying stinging insects, and more particularly relates to a sprayer apparatus for thwarting flying stinging insect attacks. Still more particularly, the present invention relates to apparatus and methods for delivering a spray or mist of a surfactant solution to stop an attack of such insects and to assist potential victims in evading such attacks.

### BACKGROUND

Despite their value as pollinators and producers of honey and wax, bees are generally unwelcome in the vicinity of people because of the possibility that the bees may swarm, attack, and repeatedly sting those nearby. Bees may attack unsuspecting persons without provocation, and leave the person without a defense to the swarm. Increasing the concerns associated with bee attacks is the migration of “Africanized” honeybees into the southern regions of the United States. These Africanized honeybees attack with more intensity and persistence than the indigenous species of honeybee, often stinging their victim hundreds of times. With the movement of Africanized honeybees, or so-called “killer bees,” into an area, it becomes even more important to make available means to protect against and end attacks by swarming bees before the results are fatal.

Research has shown that a person may defend against attacks from certain bees by exposing the bees to a surfactant solution spray or mist. In some instances, the a surfactant solution may comprise a mixture of soap and water. The soap, upon contacting a bee, breaks down the waxy protective covering of the bee's breathing system, thereby drowning the bees in the water. Sprayer devices that deliver a low volume flow of a surfactant solution spray or mist in response to an attack are may be effective for controlling and possibly killing certain less aggressive, indigenous bees. However, a low volume a surfactant solution spray or mist response may not be suitable to combat an attack by a swarm of more aggressive “killer bees” given the greater intensity and persistence of attack.

A surfactant solution spray or mist method of bee protection may be effective and practicable in situations where a capable sprayer device is readily available and can be quickly moved into proximity to apply the surfactant solution spray or mist to the person under attack. Even then, however, a person under attack by stinging bees may become incapacitated and unable set up and operate the equipment alone, and thus must to wait for help to arrive. The victim is typically forced to wait for the arrival of the fire department or another responder with the capability to rescue a victim from a stinging fling insect attack. To further compound the problem, attacks by aggressive bees often occur in remote locations where prompt response from the fire department or another responder is unlikely or even impossible, thereby making it unreliable for a high volume sprayer device to arrive in time and end the attack. Ranchers and farmers, for example, are frequently alone when attacked, such as when operating a tractor, entering a remote barn or shed, cutting brush, or fixing fences. As such, a need exists for a system that can provide a spray, mist or stream of a surfactant solution with enough intensity to effectively protect against and/or stop a large swarm of aggressive killer bees, and that can be arranged to be self-administered with little thought or coordinated effort when under the stress of an attack.

### SUMMARY

In accordance with certain embodiments, an assembly for stopping an attack of aggressive flying stinging insects on an operator of a ridable vehicle is provided. Such an assembly comprises a tank configured to contain a surfactant solution; a pump in fluid communication with the tank; a delivery system having at least one nozzle; a first tubular member fluidly connecting the tank and the delivery system; and an actuator coupled to the pump and operable by the operator, for activating the pump; wherein the tank, the pump, the delivery system, and the first tubular member are attached to the ridable vehicle and configured to deliver the surfactant solution onto the operator and the attacking insects at a flow rate in the range of 1-3 gallons/min, to dispel the insect attack, upon operation of the actuator when the assembly is used to stop an attack of aggressive flying stinging insects.

In some embodiments, the tank, pump and delivery system of the assembly are configured to expel the surfactant solution a distance of at least six feet from the at least one nozzle. In embodiments, the tank of the assembly contains the surfactant solution. In some embodiments, the surfactant solution comprises a 1:10 mixture of soap and water. In some embodiments, the at least one nozzle of the assembly is either overhead-mounted or is mounted behind the operator with respect to the position of the operator when the operator is riding the vehicle. In some embodiments, the delivery system of the assembly comprises an overhead-mounted manually activated trigger sprayer. In some embodiments, the delivery system of the assembly comprises a plurality of nozzles mounted on the ridable vehicle overhead, behind, or both overhead and behind with respect to the position of the operator when riding the vehicle.

In some embodiments, the at least one nozzle of the assembly is oriented to spray in the direction of the operator when riding the vehicle. In some embodiments, the assembly is configured to deliver the surfactant solution in a spray pattern up to eight feet in diameter about the operator. In some embodiments, the delivery system of the assembly comprises a second tubular member having a generally circular shape. In some embodiments, the delivery system of the assembly is removably attached to the ridable vehicle and is further configured to allow the surfactant solution to be expelled at a location away from the ridable vehicle when the delivery system is detached from the vehicle. In some embodiments, the assembly further comprises a secondary delivery system in fluid communication with the tank and configured for spraying the surfactant solution at a location away from the vehicle.

In some embodiments, a method of stopping an attack of aggressive flying stinging insects on an operator of a ridable vehicle is provided. The method comprises (1) providing an assembly as described herein, wherein the tank contains the surfactant solution; (2) providing a source of power to the pump; (3) engaging the actuator of the assembly to activate the pump when an attack of aggressive flying stinging insects occurs; and (4) spraying the surfactant solution via the assembly onto the operator and the aggressive attacking insects with sufficient intensity to dispel the insect attack, the operator being positioned for riding the vehicle. In embodiments, the surfactant solution is sprayed at a flow rate in the range of 1-3 gallons/min. In some embodiments, the surfactant solution is sprayed a distance of at least six feet from the at least one nozzle. In some embodiments, the surfactant solution is sprayed in a spray pattern up to eight feet in diameter about the operator.

In some embodiments, a method of stopping an attack of aggressive flying stinging insects on an individual is provided. The method comprises (1) providing an assembly as described herein, wherein the tank contains the surfactant solution; (2) providing a source of power to the pump; (3) detaching the delivery system from the ridable vehicle when an attack of aggressive flying stinging insects on the individual occurs; (4) engaging the actuator of the assembly to activate the pump; and (5) spraying the surfactant solution via the assembly onto the individual under attack and the aggressive attacking insects with sufficient intensity to dispel the insect attack. In some embodiments, the surfactant solution is sprayed at a flow rate in the range of 1-3 gallons/min.

These and other embodiments and potential advantages will be apparent with reference to the following description and drawings.

### BRIEF DESCRIPTION OF THE DRAWINGS

In the drawings and description that follows, like parts are marked throughout the specification and drawings with the same reference numerals, respectively. The drawing figures are not necessarily to scale. Certain features may be shown exaggerated in scale or in somewhat schematic form, and some details of conventional elements may not be shown in the interest of clarity and conciseness.

For a more detailed description of various embodiments, reference will now be made to the following accompanying drawings, wherein:

FIG. 1A is a schematic elevation view of a halo embodiment of the flying insect protection device disposed on a farm tractor;

FIG. 1B is a schematic elevation view of a nozzle embodiment of the flying insect protection device disposed on a farm tractor;

FIG. 2A is a top view of a halo embodiment of the delivery system;

FIG. 2B is a partial cross-sectional view of the halo embodiment shown in FIG. 2A;

FIG. 3A is a cross-section view of a sprayer embodiment of the delivery system;

FIG. 3B is a front view of the sprayer embodiment of the delivery system shown in FIG. 3A;

FIG. 3C is a cross-sectional view of a straight-line sprayer embodiment of the delivery system;

FIG. 4 is a cross-sectional view of a tank used in one embodiment of the delivery system;

FIG. 5 is a schematic elevation view of a flying insect protection device disposed on a wagon;

FIG. 6 is a schematic elevation view of a flying insect protection device disposed on a hand-truck or dolly;

FIG. 7 is an elevation view of one embodiment of the delivery system in use;

FIG. 8 is a schematic elevation view of a modular flying insect protection device disposed on a farm tractor;

FIG. 9A is a schematic view of the tank of a modular flying insect protection device;

FIG. 9B is a schematic side view of the tank of a modular flying insect protection device;

FIG. 10A is a schematic view of a handheld pressure sprayer embodiment of the delivery system; and

FIG. 10B is a schematic view of a coiled hose of the modular flying insect protection device.

### NOTATION AND NOMENCLATURE

Certain terms are used throughout the following description and claims to refer to particular system components. This document does not intend to distinguish between components that differ in name but not function. As used herein, the phrase “fluidly connected” means that the components are interconnected in a manner that permits fluid flow there between, whether or not said components are connected to one another directly or indirectly via another means of fluid connection. As used herein, the term “surfactant” refers to a surface-active agent.

The use of any form of the terms “connect”, “engage”, “couple”, “attach”, or any other term describing an interaction between elements is not meant to limit the interaction to direct interaction between the elements and may also include indirect interaction between the elements described.

As used in this disclosure, “ridable vehicles” include any suitable ridable vehicle or outdoor equipment that may expose the rider or operator to attack by flying stinging insects, such as tractors, all terrain vehicles (ATVs), trucks, bulldozers, backhoes, mowers, and wheeled rescue vehicles, for example.

The term “flying stinging insect” or “flying insects” applies to domestic honeybees or Africanized (“killer”) bees, wasps, hornets, yellow jackets, or any other flying insects that can swarm or attack an individual or individuals.

The terms “including” and “comprising” are used in an open-ended fashion, and thus should be interpreted to mean “including, but not limited to . . . ”.

### DETAILED DESCRIPTION

The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results.

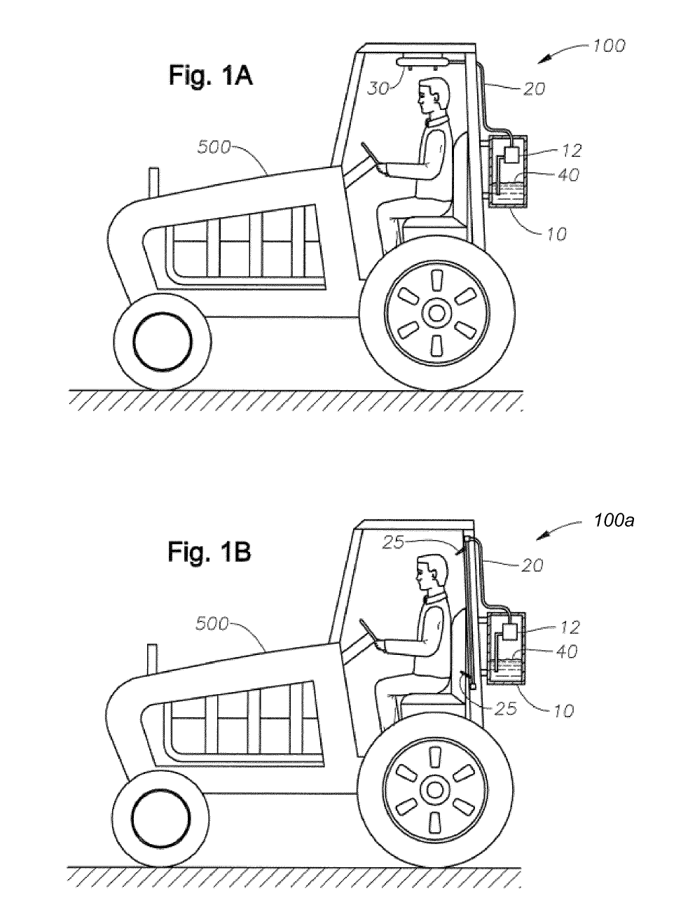

Referring initially to FIG. 1A, flying insect protection device 100 is shown in operable position on a tractor 500. Flying insect protection device 100 includes tank 10, electric pump 12, hose 20, and delivery system 30. Tank 10 is configured to contain a volume of surfactant solution 40. Electric pump 12 is preferably a self-priming, diaphragm pump that is positioned integrally to tank 10, and is preferably powered by a DC motor (not shown). In some cases, an actuator, such as a button, is connected with electric pump 12 and may be placed in front of the operator. In some cases, an actuator that is easily accessible to the operator is integrated into the ridable vehicle. For example, the actuator may comprise a foot pedal, handle, or button that is conveniently located next to the operator of the ridable vehicle, and may be quickly and easily engaged by the operator with little thought or coordinated effort. Electric pump 12 is activated by the actuator. Hose 20 is connected between tank 10 and delivery system 30. For example, hose 20 is a tubular line, and may be comprised of rubber, plastic, or other suitable flexible tubular material. Hose 20 may likewise be comprised of rigid or non-rigid conduit. Tank 10 is of sufficient capacity to hold a desired amount of surfactant solution. For example, in some applications, tank 10 is filled with surfactant solution 40 and may have a volumetric capacity in the range of four to twenty gallons. In some embodiments, tank 10 may have a volumetric capacity of thirty gallons or more. In one exemplary embodiment, tank 40 preferably has a volumetric capacity of 16 gallons. Tank 10 is comprised of plastic such as LDPE, fiberglass, or any other suitable light-weight material. In the exemplary embodiment illustrated in FIG. 1A, tank 10 and delivery system 30 of flying insect protection device 100 are mounted to a wheeled, ridable vehicle, such as tractor 500, with the delivery system 30 preferably positioned in an area above the operator of tractor 500. In various embodiments, other types of wheeled vehicles may be used similarly, such as all terrain vehicles (ATVs), trucks, bull dozers, backhoes, mowers, wheeled rescue vehicles, and any other suitable ridable vehicles or outdoor equipment. Any type of vehicle that exposes the rider or operator to flying insect attack is contemplated for use in conjunction with embodiments of an insect protection device disclosed herein. The DC motor driving electric pump 12 is preferably powered by connection to the battery (not shown) of tractor 500. Delivery system 30 is mounted to the tractor over the head of the rider, and is configured to direct the spray from the delivery system 30 downward onto the rider of the tractor.

Referring now to FIG. 1B, an alternative embodiment of a flying insect protection device is shown, in operable position on tractor 500. Device 100a includes tank 10, electric pump 12, hose 20, and spray jets 25. Tank 10 is configured to contain a volume of surfactant solution 40. In some cases, an actuator (e.g., a button) is connected with electric pump 12 and may be placed in front of or behind the operator for easy access. In some cases, the actuator is integrated into the ridable vehicle and is easily accessible to the operator. For example, the actuator may be a foot pedal that is conveniently located next to the operator of the ridable vehicle, and which may be quickly and easily engaged by the operator with little thought or coordinated effort. Two or more spray jets 25 are mounted to tractor 500 in proximity to the operator and are fluidly connected to tank 10 via hose 20. As illustrated in FIG. 1B, spray jets 25 may be mounted to the ridable vehicle behind the rider and configured to spray the rider's head and upper and/or lower body. In some cases, spray jets 25 may be mounted above the operator and to the left and the right of the operator, so that, during use, the operator is surrounded on at least three sides with the spray from the jets. Spray jets 25 may be comprised of brass, for example, and configured to deliver a wide-field spray of surfactant solution 40, a more concentrated direct stream of surfactant solution 40, or some combination thereof.

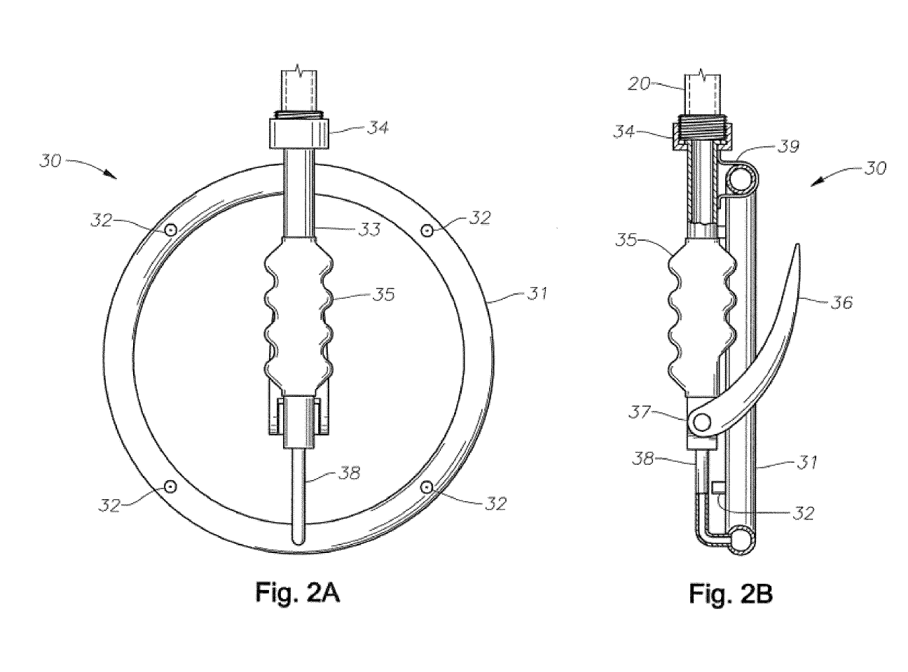

Referring now to FIGS. 2A and 2B, an embodiment of delivery system 30 is shown. In this embodiment, delivery system 30 comprises header 31 and a plurality of spray nozzles 32. Header 31 is a tubular member, formed in a halo-like shape, which may be comprised of ½-inch diameter stainless steel piping. As illustrated in FIGS. 2A and 2B, header 31 forms a circular halo that is approximately 12 to 24 inches in diameter. Spray nozzles 32 are mounted on the outer surface of header 31, spaced equally on header 31, and in fluid communication with the interior diameter of header 31. Nozzles 32 may be comprised of brass, and may deliver a wide-field spray of surfactant solution 40, a more concentrated direct stream of surfactant solution 40, or some combination thereof. Header 31 need not be circular in all applications, however. For example, in some cases, header 31 may be arcuate or linear, depending on the configuration of the vehicle where the header will be attached, and on the preference of the user.

In some embodiments, delivery system 30 also includes supply tubing 33, hose couple 34, grip 35, trigger 36, valve 37, and feed tubing 38. In some cases, actuating trigger 36 (FIG. 2B) is included in addition to an actuator as previously described. Supply tubing 33 is a tubular member capable of fluid communication, and is connected between hose couple 34 and grip 35. Supply tubing 33 is oriented radially to header 31, and may be secured to header 31 by clamp 39. Supply tubing 33 connects with grip 35 at one end, creating a passage for fluid flow into grip 35 when hose 20 is attached to hose couple 34. Grip 35 is capable of fluid communication, and incorporates trigger 36, which is used to open and/or close valve 37 located in the fluid path when trigger 36 is depressed. Feed tubing 38 is oriented radially with respect to header 31, and is connected between grip 35 and header 31 at the opposite end of grip 35 from supply tubing 33. Feed tubing 38 is a tubular member capable of fluid communication, and creates a passage for fluid flow such that feed tubing 38, grip 35 and header 31 are in fluid communication.

Referring to FIGS. 1A, 1B, 2A and 2B, when an operator (e.g., the rider of tractor 500) in proximity to flying insect protection device 100/100a is attacked by flying stinging insects, device 100/100a is utilized to deliver a spray or mist of surfactant solution 40 from delivery system 30 that envelopes the person under attack. The operator takes delivery system 30 in hand by grasping grip 35, actuating trigger 36 to open valve 37 and to close a switch (not shown), thereby activating electric pump 12. In some cases, the operator simply engages an actuator, such as pushing a button located on device 100/100a or on the ridable vehicle within easy reach of the operator, to activate electric pump 12 to deliver a spray of surfactant solution 40. In such cases, the operator does not need to grasp grip 35 of delivery system 30 to activate the device and trigger 36 is included or omitted. In some cases, as illustrated in FIGS. 1A, 2A and 2B, electric pump 12 pressurizes surfactant solution 40 contained in tank 10, delivering surfactant solution 40 through hose 20 to delivery system 30 under pressure. Upon reaching delivery system 30, surfactant solution 40 enters header 31 and flows to nozzles 32. The pressure on surfactant solution 40 created by electric pump 12 forces surfactant solution 40 through nozzles 32, thereby delivering surfactant solution 40 in a stream, spray, mist or small droplets. In some other cases, as illustrated in FIG. 1B, surfactant solution 40 is delivered from tank 10 via hose 20 to spray jets 25 under pressure from electric pump 12, and is expelled from spray jets 25 in the direction of the operator. As the column of spray or mist of surfactant solution 40 is applied to and envelopes the operator under attack, the spray or mist of surfactant solution 40 also contacts the attacking/flying stinging insects in the vicinity. The attacking flying insects exposed to the spray or mist of surfactant solution 40 from delivery system 30 are therefore stopped. In some cases, the attacking flying insects may be killed by surfactant solution 40.

It is preferred that electric pump 12 deliver the spray of surfactant solution 40 through spray nozzles 32 at a flow rate of 1-3 gallons per minute. In some cases, the flow rate is greater. In some cases, the surfactant solution is expelled a distance of at least 6 feet from delivery system 30. Preferably, delivery system 30, shown in FIGS. 2A and 2B, has a maximum linear range of 6 to 8 feet, and provides a coverage area based on a spray zone of about 6 feet in diameter. In some cases, surfactant solution 40 is a soap-water mixture, in which the ratio of soap to water is 1:10. In some cases, surfactant solution 40 contains a 1:10 mixture of detergent and water, or a 1:10 mixture of shampoo and water. Although generally less preferred, in some applications, solution 40 may also include a suitable pesticide that is nontoxic or of low toxicity to humans.

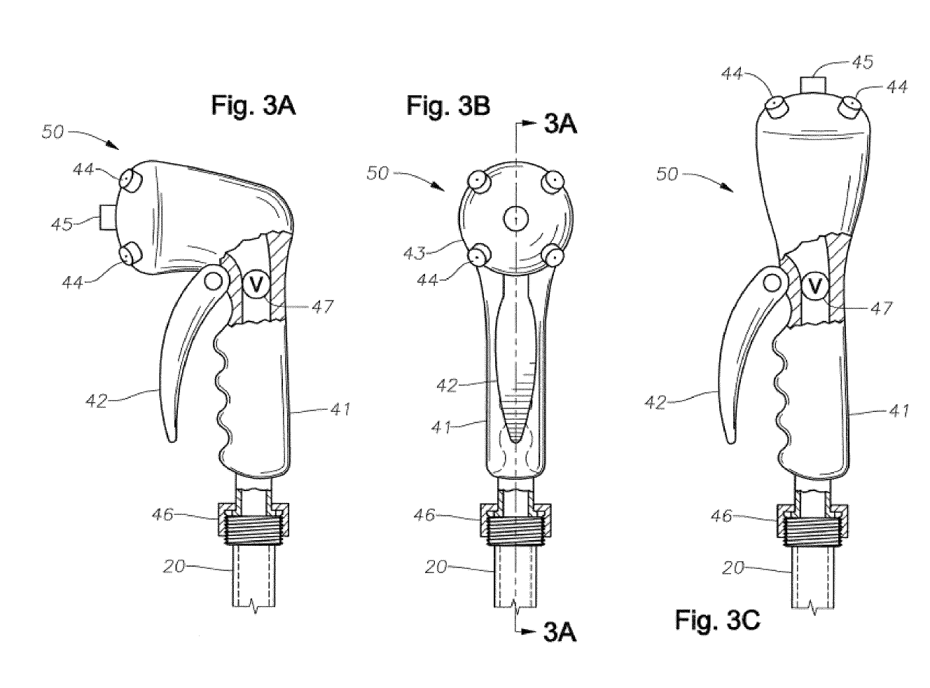

Referring to FIGS. 3A, 3B and 3C, a flying insect protection device may alternatively use a hand-held delivery system 50, as shown. In one embodiment, delivery system 50 includes grip 41, trigger 42, nozzle head 43, nozzles 44 and 45, valve 47, and hose couple 46. Delivery system 50 may be generally “L-shaped” and in the style of a garden-watering sprayer, with nozzle head 43 and nozzles 44 and 45 disposed at one end and hose couple 46 disposed at a second end. Delivery system 50 may alternatively be a straight-line sprayer with nozzles 44 and 45 disposed at one end and hose couple 46 disposed at a second end. Grip 41 is of the garden-sprayer type, with an internal passage for fluid flow. Hose couple 46 is connected at one end of grip 41 and provides an entry port for surfactant solution 40 to enter delivery system 50. Hose 20 attaches to hose couple 46, thereby fluidly connecting grip 41 and tank 10. Trigger 42 is disposed on grip 41, and trigger 42 is activated to open and close valve 47 located in the internal passage of grip 41 to control fluid flow.

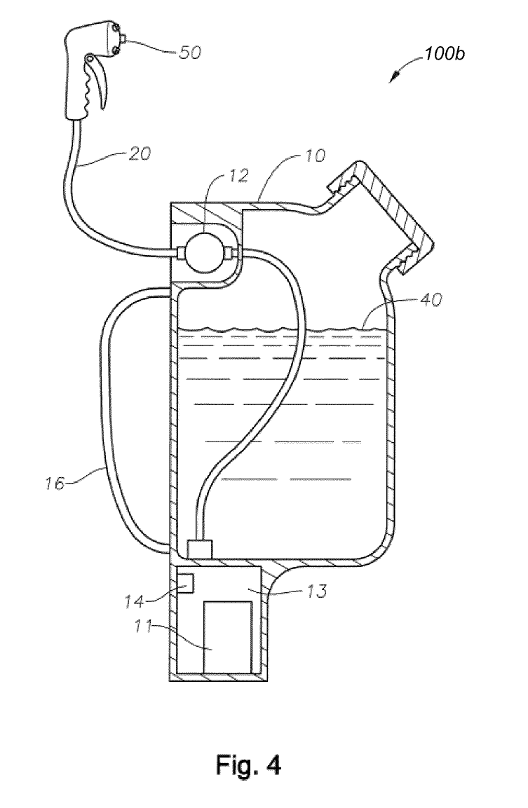

In operation, valve 47 is opened by actuating trigger 42. Depressing trigger 42 further activates a switch (not shown) that energizes electric pump 12, which pressurizes surfactant solution 40 in tank 10. Surfactant solution 40 is delivered under pressure via hose 20 to delivery system 50, and flows through grip 41 to nozzles 44 and 45. Surfactant solution 40 is expelled through nozzles 44 as a spray and nozzle 45 as a stream, and is directed to the operator under attack by flying stinging insects (e.g., bees). Surfactant solution 40 encompasses the operator and contacts the flying stinging insects, thereby stopping the attack. In certain instances, the attacking insects may be killed, depending on the type of insects and the composition of the surfactant solution. Delivery system 50 is preferably used with the tank 10 embodiments shown in FIGS. 4 and 6, a hand-held with a portable or mobile carrier.

The size of tank 10 in various embodiments of the flying insect protection device is dependent upon the anticipated or desired use. Referring now to FIG. 4, in certain embodiments, tank 10 of protection device 100b is configured such that it can be carried in a manner akin to a backpack, with shoulder straps 16 attached to tank 10 for permitting an operator to support and transport the tank on his or her shoulders and back. With tank 10 suspended from the operator's back, hose 20 connects to delivery system 50. Hose 20 may have a length in the range of 3-6 feet, for example. Tank 10 is filled with surfactant solution 40, and in some embodiments has a volumetric capacity of 4 gallons. Additionally, a battery 11 is mounted in battery housing 13, which is integrated with tank 10, in order to provide power for electric pump 12. A battery charger 14 is also included in the flying insect protection device 100b, integrated with tank 10, in order to keep battery 11 charged with sufficient power to run electric pump 12. The battery is electrically coupled to the charger and the pump.

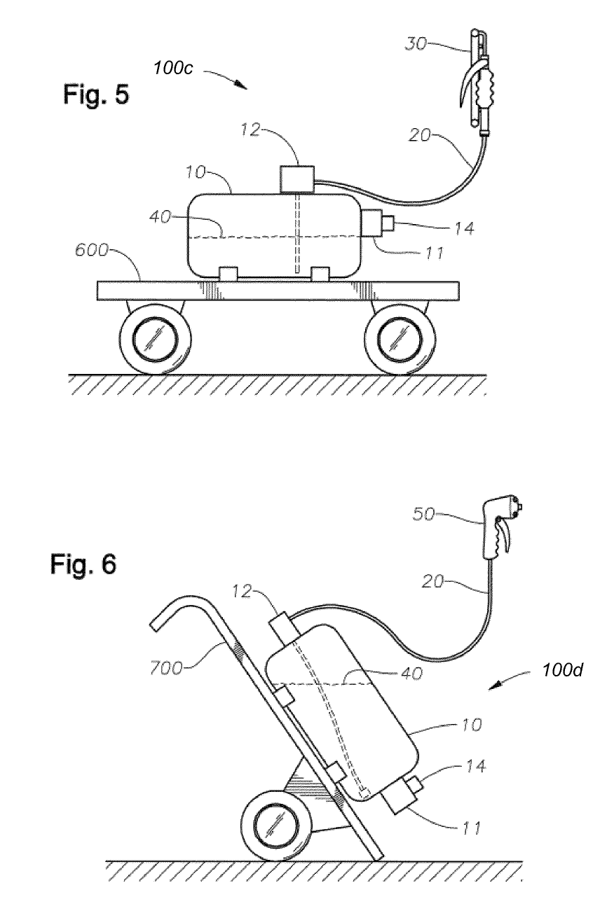

Referring now to FIG. 5, another alternative embodiment of the flying insect sprayer device is shown. Device 100c includes tank 10 mounted on a portable platform such as wagon 600. Tank 10 is filled with surfactant solution 40, and may have a volumetric capacity of 8 gallons, for example. In this embodiment, an operator may take delivery system 30 in hand and direct the spray or mist of surfactant solution 40 onto himself or herself. Alternatively, delivery system 50 may be used in this embodiment to deliver surfactant solution 40.

Referring to FIG. 6, still another alternative embodiment of a flying insect protection device is shown. Device 100d includes tank 10 mounted on a hand-truck 700. Tank 10 is filled with surfactant solution 40, and in this embodiment preferably has a volumetric capacity of 8 gallons. In this configuration, an operator may take delivery system 50 in hand and direct the spray or mist of surfactant solution 40 onto himself or herself. Alternatively, delivery system 30 may be used to deliver surfactant solution 40. Additionally, in the embodiments illustrated in FIGS. 5 and 6, battery 11 is positioned integrally to tank 10 in order to provide power for electric pump 12. A battery charger 14 is also included in these embodiments of flying insect protection device 100c/100d in a manner integral to tank 10 in order to keep battery 11 charged with sufficient power to run electric pump 12.

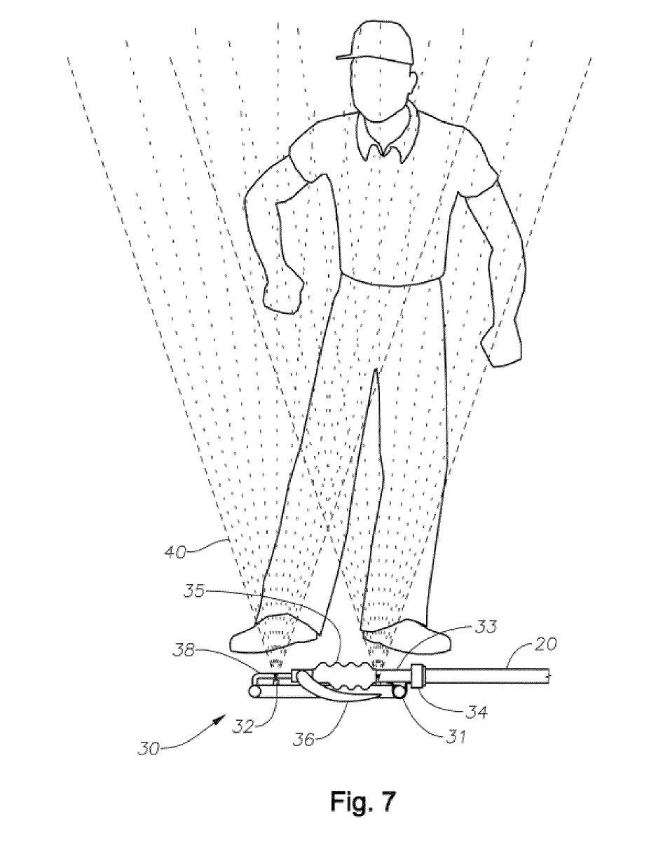

Referring to FIG. 7, an alternative use of delivery system 30 is shown, in which system 30 is positioned on the ground, allowing a person under attack from a swarm of flying stinging insects to position himself or herself within the mist or spray expelled from delivery system 30. In this embodiment, delivery system 30 is oriented such that spray nozzles 32 are directed upward. The upwardly directed spray nozzles 32 send a spray or mist of surfactant solution 40 up from the ground to create an insect defeating barrier of surfactant solution 40 that envelopes the operator. In this embodiment, the user activates delivery system 30 by actuating and locking trigger 36 in the activated position, and then placing delivery system 30 on the ground so that nozzles 32 are directed upward.

In some embodiments, delivery system 30 is removably fixed or attached onto a vehicle (e.g., tractor 500 in FIG. 1). In the event of an aggressive, flying stinging insect attack, delivery system 30 may be separated from the vehicle and used as shown in FIG. 7. The user may activate the delivery system by actuating and locking trigger 36 in the activated position or by pressing the actuator (such as a button) provided on the vehicle. In some embodiments, multiple delivery systems are included. For example, a delivery system 30 (as shown in FIG. 1A) is attached to a ridable vehicle above the operator and a second delivery system 50 (as shown in FIG. 4) is also attached to the tank. Such a configuration provides protection for both the operator and another individual that may be subject to insect attack. In certain instances, the flying insect protection device is utilized to stop the attack of flying insects upon an animal in proximity to the vehicle or a portable device, for example.

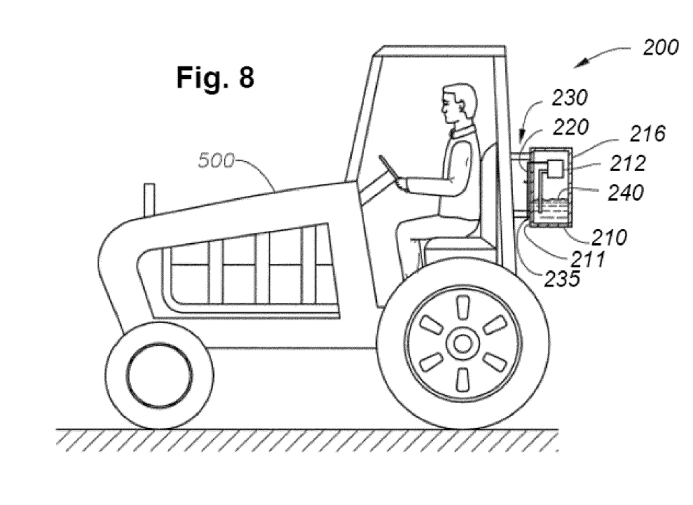

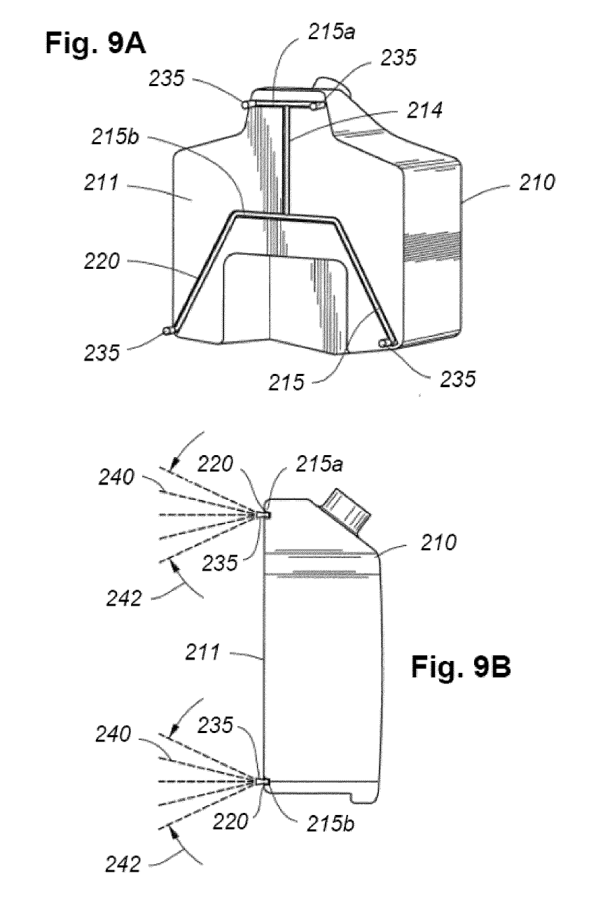

Referring now to FIG. 8, a modular flying insect protection device 200 is shown. Modular flying insect protection device 200 includes tank 210, electric pump 212, tubular member 220, and delivery system 230. In some embodiments, the modular device also includes a surfactant solution (240) contained therein. Tubular member 220 and delivery system 230 are mounted on an outer surface 211 of tank 210 (see FIG. 9A). Electric pump 212 is preferably a self-priming, diaphragm pump that is mounted on an outer surface of or within tank 210, and is preferably powered by a DC motor (not shown). An actuator (not shown) which is easily accessible to the operator is connected with electric pump 212. Electric pump 212 is activated by the actuator. Tank 210 is mounted directly to a mobile conveyance, such as tractor 500 shown in FIG. 8. The DC motor driving electric pump 212 is preferably powered by connection to the battery (not shown) of tractor 500. In certain embodiments, tank 210 is comprised of plastic, such as LDPE, or may alternatively be comprised of fiberglass or any other suitable light-weight material.

Referring to FIG. 9A, an exemplary modular device suitable for use on a ridable vehicle (as in FIG. 8) is shown. Tank 210 is characterized on at least one outer surface by channel 214. Channel 214 is preferably formed on outer surface 211 of tank 210 during the manufacturing process, and is approximately one and a half inches deep and one and a half inches wide. Channel 214 is oriented in a vertical position on outer surface 211 of tank 210, and has a first and second end from which branches 215a and 215b are formed. Branches 215a and 215b are formed on outer surface 211 of tank 210 during the manufacturing process, and are the same depth and width as channel 214. Branch 215a may be positioned in a horizontal orientation relative to the operational position of tank 210, while branch 215b may be positioned in a diagonal orientation relative to the operational position of tank 210. Tubular member 220 is positioned and secured on the outer surface 211 of tank 210 within channel 214 and branches 215a and 215b. Tubular member 220 is fluidly connected between fluid reservoir 216 and delivery system 230. Tubular member 220 enters tank 210 through a threaded grommet (not shown) and extends into fluid reservoir 216. In certain embodiments, tubular member 220 is a hose, and may be comprised of rubber, plastic, or other suitable flexible tubular material. Tubular member 220 may likewise be comprised of rigid or non-rigid conduit.

Fluid reservoir 216 of tank 210 is capable of being filled with surfactant solution 240 and may have a volumetric capacity in the range of four to thirty gallons, for example. The size of tank 210 in various embodiments of modular flying insect protection device 200 is dependent upon the anticipated and/or desired use. In this particular embodiment, tank 210 preferably has a volumetric capacity of sixteen gallons. Referring again to FIG. 8, tank 210 is mounted to a wheeled, ridable vehicle or a mobile conveyance, such as tractor 500 or any other type of ridable outdoor vehicle in which the rider may be exposed to possible attack by a swarm of flying stinging insects (e.g., bees). The configuration of tank 210 is such that it may be connected to tractor 500 with components tubular member 220, delivery system 230, electric pump 212, and an actuator integrally attached to tank 210, thereby providing the modular characteristic of certain embodiments. In some embodiments, the modular unit additionally contains a surfactant solution 40. Tank 210 is preferably positioned in an area behind the operator of tractor 500, and is oriented in such a manner that outer surface 211 of tank 210, containing channel 214 and branches 215a and 215b, is adjacent to and faces the back of the operator (e.g., the rider of tractor 500).

Referring to FIG. 9A, in certain embodiments, delivery system 230 comprises a plurality of nozzles 235. Nozzles 235 are mounted to tank 210 in proximity to the operator of tractor 500 and are fluidly connected to the portions of tubular member 220 positioned in branches 215a and 215b. More specifically, in certain embodiments nozzles 235 may be situated at four locations within branches 215a and 215b on tank 210, and are directed toward the operator. The four locations of nozzles 235 may be distributed across the length and width of tank 210, such that a first pair of nozzles 235 are located at a first, upper elevation within branch 215a, and a second pair of nozzles 235 are located at a second, lower elevation within branch 215b. Further, one of each of the first pair and second pair of nozzles 235 are located to the left side and right side of the centerline of tank 210, thereby providing a source of surfactant solution 240 that is capable of surrounding the operator on at least three sides. Surfactant solution 240 is delivered from tank 210 via tubular member 220 to nozzles 235 under pressure from electric pump 212, and is expelled from nozzles 235 in the direction of the operator. Nozzles 235 may be comprised of brass, and may deliver a wide-field, conical-shaped spray (as illustrated by the dashed lines in FIG. 9B) of surfactant solution 240, a more concentrated direct stream of surfactant solution 240, or some combination thereof.

When an operator riding a mobile conveyance such as tractor 500 equipped with a modular flying insect protection device 200 is attacked by flying stinging insects, device 200 is utilized to deliver a spray or mist of surfactant solution 240 from nozzles 235 that envelopes the operator under attack. Electric pump 212 pressurizes surfactant solution 240 contained in fluid reservoir 216 of tank 210, delivering surfactant solution 240 under pressure through tubular member 220 located in channel 214 and branches 215a and 215b to nozzles 235. The pressure on surfactant solution 240 created by electric pump 212 forces surfactant solution 240 through nozzles 235, thereby delivering surfactant solution 240 in a stream, spray, mist or small droplets. As the field of spray or mist of surfactant solution 240 is applied to and envelops the operator under attack, the spray or mist of surfactant solution 240 also contacts the attacking insects in the vicinity. The attacking insects exposed to the spray or mist of surfactant solution 40 from nozzles 35 are stopped. In some instance of use, the attacking insects may be killed, depending on the type of insects and the composition of the surfactant solution.

It is preferred that electric pump 212 deliver the spray or mist of surfactant solution 240 through spray nozzles 235 at a flow rate of 1-3 gallons per minute. In some embodiments, the flow rate is greater. Referring now to FIG. 9B, the spray or mist of surfactant solution 240 provided by delivery system 230 preferably has a maximum linear range of 6 to 8 feet, and provides a coverage area based on a spray angle between forty-five (45) and one hundred twenty (120) degrees, as designated by arrows 242 in FIG. 9B, and more preferably, about ninety (90) degrees. In certain embodiments, surfactant solution 40 is a soap-water mixture, wherein the ratio of soap to water is 1:15. For example, surfactant solution 40 may comprise a mixture of 1 gallon of ZEP® liquid soap with 15 gallons of water. Alternatively, surfactant solution 40 may comprise a 1:15 mixture of detergent and water, or a 1:15 mixture of shampoo and water, as further examples.

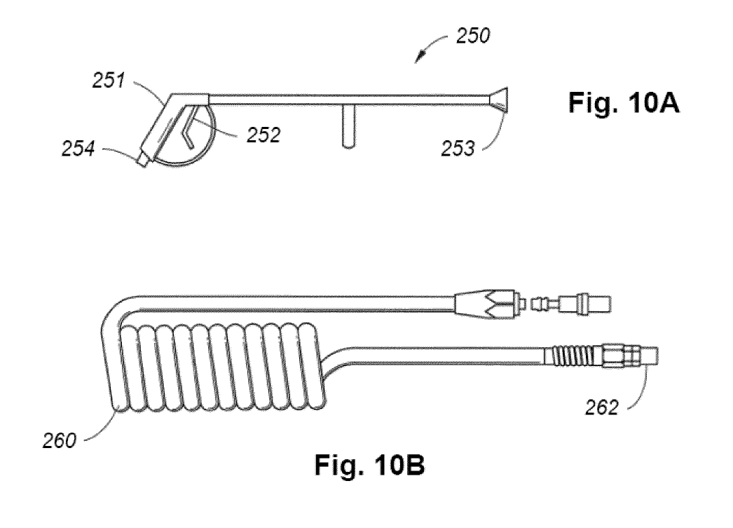

Referring now to FIGS. 10A and 10B, in some embodiments, delivery system 250 may be included concurrently with, and as a supplement to, delivery system 30 or delivery system 230, and includes a grip 251, trigger 252, spray jet 253, hose couple 254, and an internal valve (not shown). Delivery system 250 may also be provided independent of and apart from delivery system 230, in some cases. Delivery system 250 may be generally “L-shaped” and in the style of a pressure-washer sprayer, with spray jet 253 disposed at one end and hose couple 254 disposed at a second end. Hose couple 254 is connected at one end of grip 251 and provides an entry port for surfactant solution 240 to enter delivery system 250. A coiled hose 260 attaches to hose couple 254 via fitting 262, thereby fluidly connecting grip 251 and tank 210. Coiled hose 260 may be stored in an internal compartment (not shown) within tank 10 or within tank 210 separate from fluid reservoir 216 (FIG. 8). Coiled hose 260 is preferably self-retracting, may be comprised of rubber, plastic, or other suitable flexible tubular material, and may be capable of being extracted up to 20 inches out of tank 210. Trigger 252 is disposed on grip 251, and trigger 252 is activated to open and close the internal valve located in the internal passage of grip 251 to control fluid flow.

The internal valve is opened by actuating trigger 252. Depressing trigger 252 further activates a switch (not shown) that energizes electric pump 212, which pressurizes surfactant solution 240 in tank 210. Surfactant solution 240 is delivered under pressure via coiled hose 260 to delivery system 250, and flows through grip 251 to spray jet 253. Surfactant solution 240 is expelled through spray jet 253 as a spray and a stream, and is directed to the operator under attack by flying stinging insects. Delivery system 250 may be directed so that surfactant solution 240 encompasses the operator or another person or an animal in proximity but not riding the vehicle, and also contacts the flying stinging insects, thereby stopping the attack. In some instances, the attacking insects may be killed. In some cases, when more than one individual is concurrently under attack, the protection device equipped with more than more delivery system may be utilized to stop the insect attack on the more than one individual.

For some applications, a modular unit as described above, when mounted to a portable platform, allows the flying insect protection device 200 to be portable and easily accessible to an operator within a short time of an insect attack. Further, many embodiments offer the potential additional benefit of allowing an operator to engage the device by a simple pull of a trigger or the pressing of a switch. Thus, in many cases, the victim is able to stop an insect attack and to escape in a timely manner by operating the device himself without the need of outside intervention and independent of rescue efforts, despite the stress of the attack.

In some embodiments, an assembly for stopping an attack of flying stinging insects on a user is provided. Such an assembly comprises a tank containing a surfactant solution; a pump in fluid communication with the tank; a delivery system having at least one nozzle; a tubular member fluidly connecting the tank and the delivery system; wherein the tank, the pump, the delivery system, and the tubular member are incorporated into a portable platform; and an actuator, operable by the user, for activating the pump to pressurize the surfactant in order to expel the surfactant from the delivery system onto the user.

In some cases, the pump of such an assembly delivers the surfactant solution at a flow rate in the range of one gallon per minute to three gallons per minute. The surfactant solution is expelled a distance of at least six feet from the delivery system. The surfactant solution, in some cases, comprises soap and water mixed at a ratio of 1:10.

In an embodiment, the delivery system of the assembly comprises a tubular member having a generally circular shape. In an embodiment, the delivery system of the assembly comprises a hand-held trigger sprayer. In an embodiment, the delivery system of the assembly comprises a plurality of nozzles. In some embodiments, the tank of the assembly is mounted to the user as a backpack. In some embodiments, the portable platform of the assembly is a pull-wagon. In some embodiments, the portable platform of the assembly is a hand-truck. In some embodiments, the portable platform of the assembly is a wheeled rescue vehicle.

A portable assembly for stopping an attack by flying stinging insects on an operator is also provided in some embodiments. The assembly comprises a tank containing a surfactant solution and mounted to a portable platform; a delivery system having at least one nozzle and positioned in proximity to the operator; a tubular member fluidly connecting the tank and the delivery system; an electric pump adapted to convey the surfactant from the tank to the delivery system; and an actuator, operable by the operator, for causing the pump to deliver the surfactant to the delivery system under pressure, thereby causing the surfactant to be expelled from the nozzle.

In an embodiment, the delivery system of such a portable assembly comprises a plurality of nozzles. In some cases, the delivery system is a tubular member formed in a halo-like shape. In some cases, the delivery system is mounted above the operator. In some cases, the plurality of nozzles is mounted to the portable platform and is oriented to spray the operator from at least three different directions. In an embodiment, the delivery system is supported above the head of the user and the plurality of nozzles is oriented to spray in the direction of the operator. In an embodiment, the portable platform is a tractor.

In some embodiments, the pump of the portable assembly expels the surfactant solution at a flow rate of one gallon per minute to three gallons per minute. In some cases, the surfactant solution is expelled a distance of at least six feet from the delivery system. In some embodiments, the surfactant solution comprises soap and water mixed at a ratio of 1:10.

In some embodiments, a portable pumping assembly is provided that comprises a portable platform; a tank mounted on the portable platform; a solution comprising an insect-killing agent contained in the tank; a fluid delivery system comprising at least one nozzle for dispensing fluid therethrough; a conduit disposed between the tank and the fluid delivery system, the tank and fluid delivery system being in fluid communication with one another; an electric pump mounted on the portable platform and adapted to pump the solution from the tank to the delivery system and out of the nozzle; and a manual actuator adapted to activate the pump to cause the solution on the tank to be pumped through the conduit to the fluid delivery system and out of the nozzle. In some cases, delivery system further comprises a tubular header in fluid communication with the conduit, the header comprising a plurality of nozzles. In an embodiment, the header is curved.

Certain embodiments of the invention are directed to apparatus for delivering a spray or mist of an solution, such as a surfactant solution, to a person or animal being attacked by flying insects. It is desired to provide a flying insect protection device that is portable, self-contained, and can deliver a flow of a surfactant solution spray or mist sufficient to quickly kill and/or thwart a large swarm of aggressive flying insects (e.g., bees). Many embodiments of the flying insect protection device advantageously allow for use of the flying insect protection device in various environments and applications that can be utilized when rapid outside rescue response is not reliably available.

In one embodiment, a flying insect protection device includes a tank, an electric pump, a hose, a delivery system, and a surfactant solution. The tank may be comprised of plastic or fiberglass and may be sized according to the desired level of portability for each embodiment of the device. The electric pump is desired to have enough power to deliver the surfactant solution at a flow rate of 1-3 gallons per minute (GPM) and may be integral to the tank. The hose is a tubular line capable of fluid communication that is connected between the tank and the delivery system. The delivery system is characterized by a plurality of spray nozzles through which the surfactant solution is expelled. The surfactant solution is contained in the tank, and may be comprised of soap and water. In certain embodiments, the delivery system includes a halo-shaped header that is supported above the head of the person to be protected. An alternative embodiment includes disposing the delivery system on the ground with the spray nozzles directed upward. In such embodiments, the spray nozzles are disposed about the halo so as to create a column-like protective spray.

The flying insect protection device is preferably portable, self-contained, and capable of being conveyed in a variety of manners. In certain embodiments, the tank is worn by the person to be protected, and includes shoulder straps, similar to a backpack. Alternatively, the tank may be mounted on a wheeled hand-truck or dolly to assist in moving the flying insect protection device to the desired location. In another embodiment, the tank is mounted on a wheeled wagon. Further, the flying insect protection device may be integrated into a wheeled rescue vehicle, such as an ambulance or fire truck. In the embodiments where the tank is mounted as a backpack, on a hand-truck, dolly or wagon, or integral to a wheeled rescue vehicle, a battery and battery charger are included as components of the flying insect protection device to power the electric pump and to maintain the battery's power, respectively. An additional alternative embodiment includes mounting the flying insect protection device to a lawn tractor or farm tractor.

When a person in proximity of a flying insect protection device is attacked by a swarm of flying insects, the person may take the delivery system in hand and activate the electric pump to pressurize the surfactant. The surfactant solution is pumped from the tank by the electric pump through the hose and to the delivery system. The surfactant solution is delivered or sprayed when pumped through the plurality of spray nozzles of the delivery system, creating a surfactant solution spray or mist that is directed to soak the person under attack. The surfactant solution spray or mist also contacts the bees attacking the victim, stopping the attack and possibly killing the flying stinging insects.

In some embodiments, a modular assembly is provided for stopping an attack of flying stinging insects on an operator. The assembly comprises a tank containing a surfactant solution, the tank mounted to a mobile conveyance; a pump in fluid communication with the tank; a delivery system having at least one nozzle; a tubular member fluidly connecting the tank and the delivery system; wherein the pump, the delivery system, and the tubular member are attached to the tank; and an actuator, operable by the operator, for activating the pump to pressurize the surfactant in order to expel the surfactant from the delivery system onto the operator. In some embodiments, the assembly comprises a pump, which delivers the surfactant solution at a flow rate in the range of one gallon per minute to three gallons per minute. In some embodiments, the surfactant solution is expelled a distance of at least six feet from the delivery system. In some embodiments, the surfactant solution is expelled from the delivery system at an angle of at least 45 degrees. In some embodiments, the surfactant solution comprises soap and water mixed at a ratio of 1:15.

In some embodiments, the delivery system of the assembly is oriented to spray in the direction of the operator. In some embodiments, the delivery system of the assembly comprises a plurality of nozzles. In some cases, the plurality of nozzles is arranged in a pattern to direct the surfactant solution in a manner that envelops the operator by spraying the operator from at least three directions. In some cases, the tank of the assembly comprises a first surface with a plurality of channels that are built into the first surface; the tubular member and the plurality of nozzles are disposed within the plurality of channels.

In some embodiments, the assembly further comprises a handheld sprayer, the handheld sprayer having a trigger; a coiled hose, the coiled hose fluidly connecting the tank and the handheld sprayer; and wherein the handheld sprayer and coiled hose are stored within the tank, and wherein the trigger is operable by the user for activating the pump to pressurize the surfactant solution in order to expel the surfactant solution from the handheld sprayer. In some cases, the mobile conveyance is a tractor.

In some embodiments, a modular pumping assembly is provided that comprises a tank mounted on a mobile conveyance; a solution comprising an insect-killing agent contained in the tank; a fluid delivery system comprising at least one nozzle for dispensing fluid therethrough; a tubular member coupled in fluid communication between the tank and the fluid delivery system; an electric pump adapted to pump the solution from the tank to the delivery system and out of the at least one nozzle; wherein the fluid delivery system, the tubular member, and the electric pump are attached to the tank; and a manual actuator adapted to activate the pump to cause the solution on the tank to be pumped through the tubular member to the fluid delivery system and out of the at least one nozzle.

In some embodiments, the pump of the assembly delivers the solution at a flow rate in the range of one gallon per minute to three gallons per minute. In some cases, the solution is expelled a distance of at least six feet from the delivery system. In some cases, the solution comprises soap and water mixed at a ratio of 1:15.

In some embodiments, the delivery system of the assembly comprises a plurality of nozzles. The solution is expelled from the plurality of nozzles in a plurality of overlapping conical-shaped fields that envelops an area immediately in front the tank. In some cases, the tank of the assembly comprises a first surface with a plurality of channels that are built into the first surface; and the tubular member and the plurality of nozzles are disposed within the plurality of channels.

In some cases, the assembly further comprises a handheld sprayer, the handheld sprayer having a trigger; a coiled hose, the coiled hose fluidly connecting the tank and the handheld sprayer; and wherein the handheld sprayer and coiled hose are stored within the tank, and wherein the trigger is operable for activating the pump to pressurize the solution in order to expel the solution from the handheld sprayer.

While preferred embodiments of the invention have been shown and described, modifications thereof can be made by one skilled in the art without departing from the scope or teaching of this invention. The embodiments described herein are exemplary only and are not limiting. It will be appreciated that many other modifications and improvements to the disclosure herein may be made without departing from the scope of the invention or the inventive concepts herein disclosed. Because many varying and different embodiments may be made within the scope of the present inventive concept, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. An assembly for stopping an attack of aggressive flying stinging insects on an operator of a ridable vehicle, the assembly comprising:
a tank configured to contain a surfactant solution;
a pump in fluid communication with the tank;
a delivery system having at least one nozzle;
a first tubular member fluidly connecting the tank and the delivery system; and
an actuator coupled to said pump and operable by the operator, for activating the pump;
wherein the tank, the pump, the delivery system, and the first tubular member are attached to said ridable vehicle and configured to deliver said surfactant solution onto the operator and the attacking insects at a flow rate in the range of 1-3 gallons/min, to dispel the insect attack, upon operation of said actuator when said assembly is used to stop an attack of aggressive flying stinging insects.

2. The assembly of claim 1 wherein said tank, pump and delivery system are configured to expel said surfactant solution a distance of at least six feet from said at least one nozzle.

3. The assembly of claim 1 wherein said tank contains said surfactant solution.

4. The assembly of claim 3 wherein said surfactant solution comprises a 1:10 mixture of soap and water.

5. The assembly of claim 1 wherein said at least one nozzle is either overhead-mounted or is mounted behind said operator with respect to the position of the operator when the operator is riding said vehicle.

6. The assembly of claim 1 wherein said delivery system comprises an overhead-mounted manually activated trigger sprayer.

7. The assembly of claim 1 wherein said delivery system comprises a plurality of nozzles mounted on said ridable vehicle overhead, behind, or both overhead and behind with respect to the position of the operator when riding said vehicle.

8. The assembly of claim 1 wherein said at least one nozzle is oriented to spray in the direction of the operator when riding said vehicle.

9. The assembly of claim 1 wherein said assembly is configured to deliver said surfactant solution in a spray pattern up to eight feet in diameter about said operator.

10. The assembly of claim 1 wherein said delivery system comprises a second tubular member having a generally circular shape.

11. The assembly of claim 1 wherein said delivery system is removably attached to said ridable vehicle and is further configured to allow said surfactant solution to be expelled at a location away from said ridable vehicle when said delivery system is detached from said vehicle.

12. The assembly of claim 1 further comprising a secondary delivery system in fluid communication with said tank and configured for spraying said surfactant solution at a location away from said vehicle.

13. An assembly for stopping an attack of aggressive flying stinging insects on an operator of a ridable vehicle, the assembly comprising:
a tank configured to contain a surfactant solution;
a pump in fluid communication with the tank;
a delivery system having at least one nozzle;
a first tubular member fluidly connecting the tank and the delivery system; and
an actuator coupled to said pump and operable by the operator, for activating the pump;
wherein said at least one nozzle is either overhead-mounted or is mounted behind said operator with respect to the position of the operator when the operator is riding said vehicle; and
wherein the tank, the pump, the delivery system, and the first tubular member are attached to said ridable vehicle and configured to deliver said surfactant solution onto the operator and the attacking insects.

14. The assembly of claim 13 wherein said surfactant solution is delivered onto the operator and the attacking insects at a flow rate in the range of 1-3 gallons/min, to dispel the insect attack, upon operation of said actuator when said assembly is used to stop an attack of aggressive flying stinging insects.

15. The assembly of claim 13 wherein said delivery system comprises a plurality of nozzles mounted on said ridable vehicle overhead, behind, or both overhead and behind with respect to the position of the operator when riding said vehicle.

16. The assembly of claim 13 wherein said assembly is configured to deliver said surfactant solution in a spray pattern up to eight feet in diameter about said operator.

17. The assembly of claim 13 wherein said delivery system is removably attached to said ridable vehicle and is further configured to allow said surfactant solution to be expelled at a location away from said ridable vehicle when said delivery system is detached from said vehicle.

18. The assembly of claim 13 further comprising a secondary delivery system in fluid communication with said tank and configured for spraying said surfactant solution at a location away from said vehicle.

19. A method of stopping an attack of aggressive flying stinging insects on an operator of a ridable vehicle, the method comprising:
providing an assembly according to claim 1, wherein said tank contains said surfactant solution;
providing a source of power to said pump;
engaging the actuator of said assembly to activate the pump when an attack of aggressive flying stinging insects occurs; and
spraying said surfactant solution via said assembly onto the operator and the aggressive attacking insects with sufficient intensity to dispel the insect attack, said operator being positioned for riding said vehicle.

20. The method of claim 19 wherein said surfactant solution is sprayed at a flow rate in the range of 1-3 gallons/min.

21. The method of claim 19, wherein said surfactant solution is sprayed a distance of at least six feet from said at least one nozzle.

22. The method of claim 19, wherein said surfactant solution is sprayed in a spray pattern up to eight feet in diameter about said operator.

23. A method of stopping an attack of aggressive flying stinging insects on an individual, the method comprising:
providing an assembly according to claim 11, wherein said tank contains said surfactant solution;
providing a source of power to said pump;
detaching said delivery system from said ridable vehicle;
engaging the actuator of said assembly to activate the pump; and
when an attack of aggressive flying stinging insects on said individual occurs, spraying said surfactant solution via said assembly onto said individual under attack and the aggressive attacking insects with sufficient intensity to dispel the insect attack.

24. The method of claim 23 wherein said surfactant solution is sprayed at a flow rate in the range of 1-3 gallons/min.
